(19) United States
(12) Patent Application Publication
(10) Pub. No.: US 2018/0344047 A1
(43) Pub. Date: Dec. 6, 2018

(54) Bed Mattress and Proceeding Making the Same

(71) Applicant: Bodylineair Production AB, Bromma (SE)

(72) Inventor: Bengt Pettersson, Vallda (SE)

(73) Assignee: Bodylineair Production AB, Bromma (SE)

(21) Appl. No.: 15/777,955

(22) PCT Filed: Nov. 18, 2016
(86) PCT No.: PCT/SE2016/051149

§ 371 Date: May 22, 2018

(30) Foreign Application Priority Data
Nov. 25, 2015 (SE) 1500488-0
Dec. 11, 2015 (SE) 1551623-0

(51) Int. Cl. A47C 27/08; A47C 27/10; A47C 27/18; A47C 27/22; B68G 7/06; A47C 27/12

(52) U.S. Cl. CPC A47C 27/088; A47C 27/10; A47C 27/128; A47C 27/22; B68G 7/06; A47C 27/18

(57) ABSTRACT

An overlay mattress includes a foil mattress of plastic material in a surrounding envelope of textile material. The foil mattress has channels and a preferably self-closing valve for filling air into the channels that are also at least partly filled with fibers of so-called ball fiber and/or with foam plastics, at least in such an amount that the plastic material of the foil mattress is mutually separated. The channels extend transversely to the longitudinal direction of the mattress, and the channels are interconnected via air passages. Methods of manufacturing such an overlay mattress are also disclosed.

The present invention concerns a bed mattress comprising a foil mattress of plastic material in a surrounding envelope of textile material, the foil mattress comprising channels and having a preferably self-closing valve for filling air into said channels.

The invention also concerns a proceeding for manufacturing a bed mattress comprising a foil mattress in a surrounding envelope of textile material, the foil mattress being provided with channels and having a preferably self-closing valve for filling air into said channels.

Concerning prior art:

### DE 202013006179U1

The overall function of the filling of the mattress is insulation.
It is defined as: “matten, ligematten oder schlafmatten” for the camping trade.
The mattress should consist of a plurality of single cells. Here, it is far from clear what they mean.
The insulating material consists of down, synthetic batting, or foam.
Their channels are longitudinal.
On an air-bed having longitudinal channels, one rolls to and fro laterally and one does not obtain effective ventilation against the mattress.
Function and the material are different and the surrounding material is not defined.
The mattress is filled with down or synthetic fibre and it gives the mattress an insulating function.
Their channels are longitudinal.
The object of the mattress is that it should minimize heat loss and be filled with a material that should be able to be compressed extremely much so as to, in such a way, generate a low weight. It should be possible to be packed as compact as possible and be inexpensive to produce.

### JR Gear

Thin ground sheet for camping or outdoor life.
Filled with Primaloft™ for best insulating function. The filling has only an insulating function.

Air-beds are today also used for bed mattresses, the air-bed consisting of welded together plastic foil portions having channels provided between said plastic foil portions and which is provided with air filling valve of the preferably self-closing kind. A surrounding removable and washable textile material envelope forms in that connection covering for said mattress.

Upon air leakage, such a bed mattress collapses and becomes unusable, which however is a less common problem.

However, such a mattress emits a rustling sound when the one who is lying or sitting on the mattress changes position, which may be disturbing both to the one carried by the mattress and to the environment. This rustling sound, which is a more seriously problem, comes primarily from the air-bed but also from the abutment of the envelope against the outside of the air-bed.

In visco-elastic bed mattresses, for instance of the type that consists of plastic material such as silicone, a serious problem, especially to rheumatic patients, is when these persons desire to change position and turn around on the mattress. Namely, the body of the person lying on such a visco-elastic bed mattress sinks down into the mattress material and prevents, or at least makes more difficult, position change of the body. Such bed mattresses are also heavy to handle because of their compact structure and thereby greater weight. Air-beds, which are light to handle, allow turning around easily when you are lying on an air-bed, however with said sound problem and with the risk of collapse upon air leakage.

Thus, the main object of the present invention is, among other things, to solve at least the problems mentioned above by simple means and cost-effectively.

Said object is achieved by means of a bed mattress according to the present invention, which essentially is characterized in that the channels of the foil mattress are, in addition to air, entirely or partly filled with fibres of so-called ball fibre and/or with foam plastics, at least in such an amount that the plastic material in the foil mattress is mutually separated, that said channels extend transversely to the longitudinal direction of the mattress, and that said formed mattress channels are interconnected via air passages.

A further object is also to manufacture such a bed mattress easily and efficiently.

Said further object is achieved by means of a proceeding according to the present invention, which essentially is characterized in that plastic foil is welded so that the frame of the mattress is formed apart from one or more certain passages to produced channels being left open from the side of the channels, that said channels are welded transversely with air passages interconnecting a number of said channels and are filled entirely or partly with fibres and/or with foam plastics, at least in such an amount that the plastic material in the mattress is mutually separated, the valve being welded in place on the mattress before the closure of said channels.

The present invention concerns a bed mattress having transverse channels filled with ball fibre/cold foam. It is the combination of ball fibre/cold foam and air that in addition provides an optimum pressure relief for the body of the person lying on the bed mattress.

Air-beds, which have longitudinal channels, may be utilized on beaches and in camping, not as bed mattresses. Such a one has no pressure relieving function and does not intend to facilitate healing of pressure sore or facilitate for users who have back problems and/or suffer from insomnia.

### Conclusion

The mattress according to the present invention is a bed mattress for an optimum pressure relieving function for the body and it also affords an optimum bed comfort. Filling material has a pressure relieving function. Since channels are filled with ball fibre/cold foam to afford a good pressure relieving function. By in addition being able to supplement with air, the pressure relief increases and an optimum lying comfort is attained, which, among other things, contributes to faster rehabilitation or decreased pressure sore as well as decreases back problems/suffering from insomnia.

In the examples of mattresses discussed above, the filling material has in that connection the function to insulate the user from cold against the ground or another substratum when it is used in camping or open-air purpose. The object of the present invention is not to pack small and be inexpensive to produce but concerns a quality product, which makes everyday life considerably better since it improves sleep quality. It is a bed mattress having transverse channels that are filled with ball fibre/cold foam which is intended according to the invention and which in addition to decreasing back problems/suffering from insomnia also affords assuagement in the healing of pressure sore. The combination of ball fibre/cold foam and air in transverse channels is what provides an optimum pressure relief.

The invention is described below in the form of a number of preferred embodiment examples, reference being made to the accompanying drawings, in which,

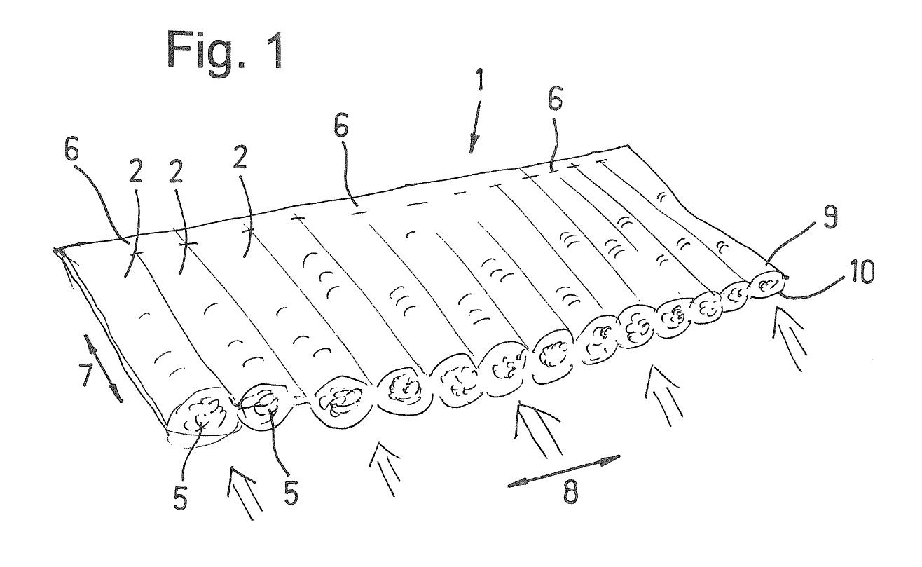

FIG. 1 shows a perspective view of a bed mattress according to the invention, where a filling is shown how it is stuffed or blown into intended air channels of an air-fillable bed mattress in shown open position along one long side thereof,

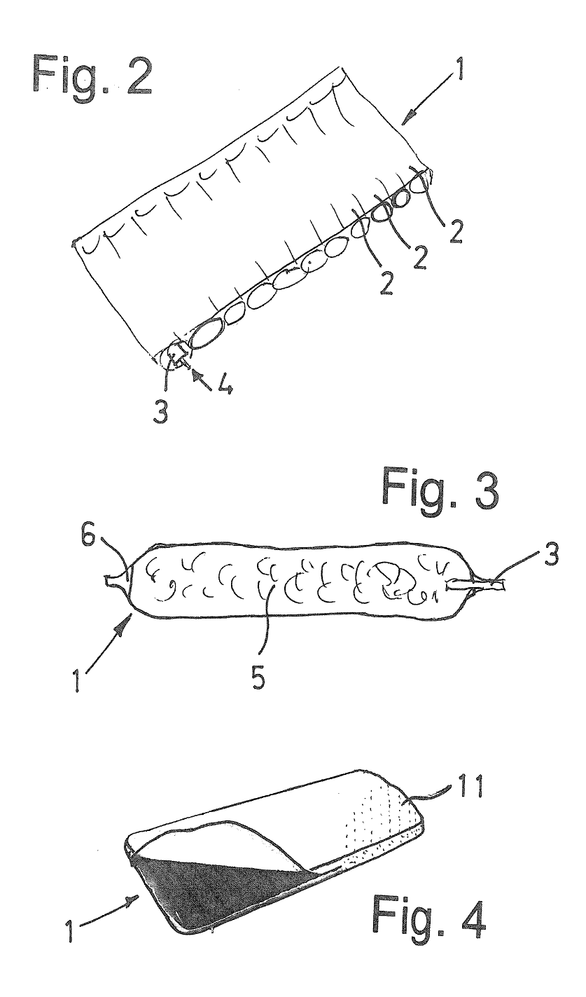

FIG. 2 shows a valve mounted on the bed mattress before welding together the side edge thereof,

FIG. 3 shows a cross-section of completed bed mattress,

FIG. 4 shows the bed mattress put into a surrounding envelope having partly upturned envelope portion,

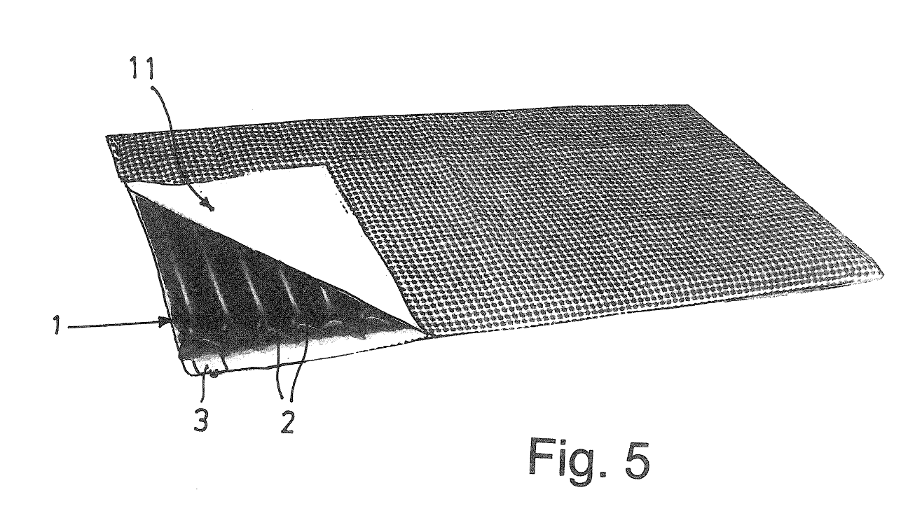

FIG. 5 likewise shows a bed mattress contained in an envelope with valve shown,

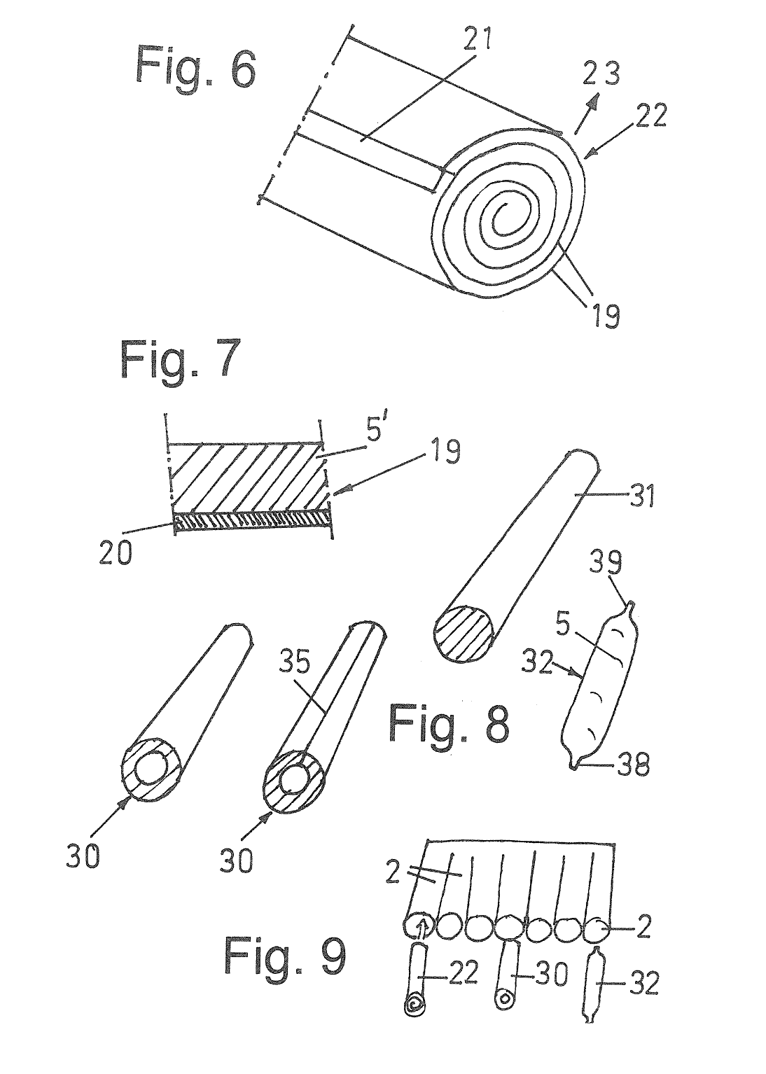

FIG. 6 shows example of a part of a roll-formed provided upholstery of foam plastics,

FIG. 7 shows a cross-section of laminated foam plastics having a protective layer of textile and which is used as upholstery,

FIG. 8 shows different examples of upholsteries that may be utilized,

FIG. 9 shows a filling procedure of the proper plastic foil mattress using different upholsteries of various kinds, and

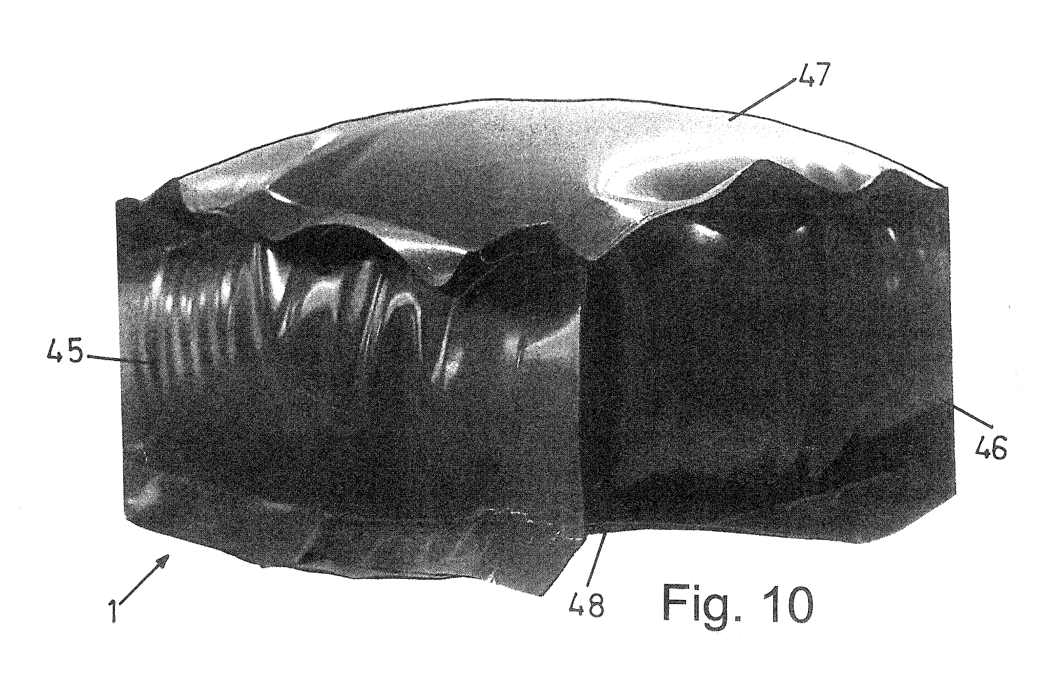

FIG. 10 shows the edges of the bed mattress with belonging side- and edge pieces.

The present invention concerns a bed mattress wherein an air-bed which, in addition to air, is filled with polyester fibre or foam plastics or both things entirely or partly, in order to, among other things, prevent rustle sound from the foil of the air-bed when someone is sitting or lying on the mattress.
The filling in the mattress affords a sound reduction and, in addition, the comfort is improved and affords accordingly a double effect.
The internally situated air-bed should be formed with transverse air channels for the best comfort and an even support to the body.
The valve for filling air and emptying should preferably have a self-sealing function so as to easily be able to adjust the mattress to desired softness degree.
Another advantage of the filling of fibre and/or the foam plastics is that the mattress does not collapse and becomes unusable if the air has leaked out unintentionally.
   The advantage of the construction is also that the mattress gets an essentially lower weight than visco-elastic mattresses of known type which lock the body since then one sinks down into the mattress in correspondence with the shape of the body. For instance for rheumatic patients, which is a well-known problem when they should change position and turn around. This does not occur in the air-fibre mattress™ on which it is easy to turn around without hindrance.

The mattress can be washed off and no skin deposits and mite can penetrate down therein, neither urine.

The mattress is excellent for medical treatment and has effective pressure relief capacity. Between each transverse air channel, a ventilating channel is formed to get body heat and moisture to be removed.

The mattress will be much more inexpensive than the visco-elastic mattresses. Covering for the mattresses can be used in usual embodiments.

According to the invention, there is intended, in the production process of the air-bed, to create a number of air channels, which are provided by welding plastic foil so that an opening is formed at one end of each channel where filling of fibre and/or foam plastic material can be effected to an amount and volume that is suitable to keep apart the plastic material in the channels of the air-bed. Next, the channels of the air-bed are welded up by the arrangement of a preferably self-sealing valve for filling air or emptying air according to needs and desire. Thereby, the problem of air-bed mattresses is solved, that these rustle by the plastic foil material itself or from the material of the covering surrounding the plastic mattress, when you are lying or sitting on the air-bed. Thus, the problem is solved thanks to the invention by filling the air-bed with fibre material and/or foam plastic material, which efficiently damps disturbing rustle sounds, thereby solving a serious problem existing today of air-bed mattresses.

A bed mattress 1, which is provided with a plurality of channels 2 and having a preferably self-closing valve 3 intended and adapted for filling air 4 into said channels 2, has, according to the present invention, received fibres 5 and/or foam plastics, such as polyether, in said channels 2 of the bed mattress, in addition to air 4. Said fibres 5 are suitably of the type that is denominated ball fibre and which has curved fibre threads, which give rise to excellent resilience, and which preferably are made up of polyester fibre. Said channels 2 are entirely or partly filled with fibres 5 and/or foam plastics in the amount and volume that is suitable to at least keep apart the plastic material of the mattress 1 and the channels 2 thereof.

Said filling in the foil mattress formed by plastic foil may in addition to loose filling of fibres 5 and/or foam plastics be varied according to examples shown in FIGS. 6-9. An example shown in FIG. 6 is in the form of a laminate 19 consisting of foam plastics 5¹ and protective fabric 20, e.g. of nonwoven. A said laminate 19 is rolled up, similar to the shape of a jelly roll 22 shown in FIG. 6 and is locked up by, e.g., tape 21 and with the protective fabric 20 facing outward 23.

The protective fabric 20 facilitates, among other things, the insertion of the formed roll by the fact that the friction is decreased against surrounding plastic material of those channels 2 in which the roll is inserted.

In FIG. 8, different variants of filling are shown in the form of cellular plastics or fibre. One variant is in the form of a tube 30 which may be entirely or formed of a rolled up and glued 35 sheet. The filling may also be formed of a homogeneous foamed plastic rod 31.

The advantage of arranging tubular fillings 30 of cylindrical or quadrangular circumference shape with a contained elongate hollow space is that formed walls of such fillings 30 around a hollow space 40, drilled or provided in another way, in the centre of said fillings 30, helps to provide an effective resilience of said bed mattress 1. By varying the thickness of said walls and/or varying the density of the cellular plastics that are utilized therefor, the mattress can be adapted to the weight and shape of different persons.

With the filling of fibre 5 contained in a cylindrical sock 32, which consists, e.g., of nonwoven fabric and which is sealed 38/39 in the respective ends, the filling 5 can easily be introduced into the channels 2 of the foil mattress with no obstacle of friction.

The density of the cellular plastics therein may also be varied to fit different persons.

Air 4 may suitably flow between said channels 2 by said mattress channels 2 being interconnected via air passages 6.

For the best comfort, said channels 2 extend transversely to 7 the longitudinal direction 8 of the mattress.

As shown in FIG. 10, the edges of the bed mattress 1 composed of plastic foil may have separate side and/or edge pieces 45, 46 along long sides and/or short sides of said mattress. Thereby, a bed mattress 1 is obtained which is flat along the entire upper and under side 47, 48 thereof, without any sloping edges along the circumference of the mattress.

Furthermore, the bed mattress may be divided into zones along its longitudinal direction to increase the possibility to obtain an optimum pressure relief and comfort.

There may also be arranged a separate app which allows the air supply to, and from, respectively, the mattress to be adjusted.

A suitable proceeding for manufacturing a bed mattress 1, which is provided with channels 2 and having a preferably self-closing valve 3 for filling air 4 takes place according to the present invention in such a way that plastic foil is welded so that the frame of the mattress 1 is formed, apart from one or more certain passages to produced channels 2 being left open from the side, so that communication for air to flow between the channels 2 is allowed. Next, said channels 2 are filled entirely or partly with fibres 5 and/or with foam plastics, such as polyether, at least in such an amount that the plastic material 9, 10 of upper and under side, respectively, of the mattress 1 is mutually separated, with or without intermediate edge pieces 45, 46. The valve 3 is also welded in place on the mattress 1 before the closure of said channels 2 and preferably before the filling of the same. In that connection, said channels 2 are welded transversely 7 with air passages 6 interconnecting a number of said channels 2. Zone division of the mattress 1 may in that connection be provided. Suitably, the filling material is stuffed or blown into said channels 2 whereupon the plastic foil is welded in a known way per se and by known means in the longitudinal direction 8 of the mattress along one long side of the mattress before putting the foil mattress 1 in a surrounding envelope 11 consisting of textile material. In that connection, polyester fibre 5 or foam plastics are utilized to fill the channels 2.

In order to further increase the comfort of a said bed mattress 1, fibres or foam plastics of the type mentioned may also be placed between the outside of the mattress and the inside of the envelope before the closure of the envelope 11. Preferably, said fibres 5 or foam plastics are attached on the outside of the plastic foil mattress and/or on the inside of the envelope.

The function and nature of the invention should have been clearly understood from the above-mentioned and also with knowledge of what is shown in the drawings but the invention is naturally not limited to the embodiments described above and shown in the accompanying drawings. Modifications are feasible, particularly as for the nature of the different parts, or by using an equivalent technique, without departing from the protection area of the invention, such as it is defined in the claims.

1.-16. (canceled)

17. A bed mattress, comprising:
a foil mattress of plastic material in a surrounding envelope of textile material, the foil mattress comprising channels extending transversely to a longitudinal direction of the foil mattress, and a valve for filling air into the channels,
wherein the channels are interconnected via air passages and are, in addition to air, at least partly filled with at least one of polyester fibers and foam plastics in an amount such that the plastic material is separated; the foam plastics are cylinders, tubes, or rolled-up sheets having an outward-facing cover around the same; the foam plastics are introduced into the channels from one long side of the foil mattress; and polyester fibers are disposed in a cylindrical envelope that is inserted into the channels from one long side of the foil mattress.

18. The bed mattress of 17, wherein the polyester fibers are ball fibers and the foam plastics are polyether or cold foam.

19. The bed mattress of claim 18, wherein the at least one of polyester fibers and foam plastics are placed between an outside of the foil mattress and an inside of the envelope before closure of the envelope.

20. The bed mattress of claim 17, wherein the cover is a textile material that has low friction against internal surfaces of the channels.

21. The bed mattress of claim 17, wherein polyester fibers in the channels having equal or varying density along at least portions of a length extension of the bed mattress.

22. The bed mattress of claim 17, wherein the channels have cylindrical cross-sections.

23. A method of manufacturing a bed mattress comprising a foil mattress in a surrounding envelope of textile material, the foil mattress having channels and a valve for filling air into the channels, the method comprising:
welding the plastic foil so that a frame of the foil mattress is formed apart from one or more air passages to the channels left open from a side of the channels;
welding the channels transversely to a longitudinal direction of the foil mattress with air passages interconnecting a number of the channels that are at least partly filled with at least one of polyester fibers and foam plastics at least in such an amount that a plastic material in the foil mattress is mutually separated;
welding the valve in place on the foil mattress before closure of the channels; and
at least partly filling channels with foam plastics in the form of tubes, cylinders, or rolled up sheets or with polyester fibers, either of which is covered by a textile having low friction and facing outward from a long side of the foil mattress.

24. The method of claim 23, wherein the polyester fibers or foam plastics are stuffed or blown into the channels, whereupon the plastic foil is welded in the longitudinal direction along the long side before putting the foil mattress in a surrounding envelope of textile material.

25. The method of claim 23, wherein foam plastic sheets having fabric on one side thereof are rolled into cylinders with the fabric facing outward, whereupon the cylinders are inserted into respective channels.

26. The method of claim 23, wherein the channels are filled with ball fiber or cold foam or polyether plastics.

27. The method of claim 24, wherein polyester fibers or foam plastics are placed between an outside of the foil mattress and an inside of the surrounding envelope before closure of the surrounding envelope.

28. The method of claim 23, further comprising connecting plastic edge pieces along a circumference of the foil mattress to an upper side and an under side of the foil mattress, thereby forming substantially straight portions along long or short sides of the foil mattress.
